(19) United States
(12) Patent Application Publication
(10) Pub. No.: US 2010/0066615 A1
(43) Pub. Date: Mar. 18, 2010

(54) ANTENNA DEVICE AND ELECTRONIC APPARATUS USING THE SAME

(76) Inventors: Motoyuki Okayama, Osaka (JP); Akihiro Ozaki, Gifu (JP)

Correspondence Address: WENDEROTH, LIND & PONACK L.L.P., 1030 15th Street, N.W., Suite 400 East, Washington, DC, 20005-1503, US

(21) Appl. No.: 12/516,616

(22) PCT Filed: Dec. 3, 2007
(86) PCT No.: PCT/JP2007/073290

§ 371 Date: May 28, 2009

(30) Foreign Application Priority Data
Dec. 4, 2006 (JP) 2006-326599

(51) Int. Cl. H01Q 1/24; H01Q 1/38

(52) U.S. Cl. 343/702; 343/700 MS

(57) ABSTRACT

The present invention improves reception quality in an electronic apparatus including plural antenna devices. For this purpose, first antenna device (8) of electronic apparatus (7) according to the present invention includes ground organizer (10); feeding unit (11) placed on ground organizer (10); first antenna conductor (12) with its one end connected to feeding unit (11); and second antenna conductor (13) and third antenna conductor (14) both branch connected to the other end of first antenna conductor (12). The sum of the length of first antenna conductor (12) and that of second antenna conductor (13) is substantially (¼+n/2) times the wavelength of a signal in the first frequency band, and additionally the sum of the length of second antenna conductor (13) and that of third antenna conductor (14) is substantially (½+m/2) times the wavelength of a signal in the second frequency band.

### TECHNICAL FIELD

The present invention relates to an antenna device and an electronic apparatus using the same.

### BACKGROUND ART

Hereinafter, a description is made of an electronic apparatus such as a conventional mobile communication terminal using FIG. 17. In FIG. 17, conventional electronic apparatus 1 includes first antenna device 2 communicating using a first frequency band; and second antenna device 3 communicating using a second frequency band different from the first one. First antenna device 2 and second antenna device 3 are formed on ground organizer 4 and include antenna conductors 5, 6 with each length substantially ¼ times the wavelength of a signal in each frequency band, on each antenna conductor.

There is patent literature 1, for example, known as document information on prior art related to this invention.

However, electronic apparatus 1 has been downsized in recent years; first antenna device 2 and second antenna device 3 are positioned extremely close to each other. This causes isolation between antenna conductors 5, 6 to decrease, undesirably deteriorating reception quality.
[Patent literature 1] Japanese Patent Unexamined Publication No. H11-261363

### SUMMARY OF THE INVENTION

The present invention improves reception quality in an electronic apparatus including plural antenna devices.

For this purpose, an electronic apparatus of the present invention includes a first antenna device communicating using a first frequency band; and a second antenna device communicating using a second frequency band different from the first one. The first antenna device includes a ground organizer; a feeding unit placed on the ground organizer; a first antenna conductor with its one end connected to the feeding unit; and second and third antenna conductors both branch connected to the other end of the first antenna conductor. The sum of the length of the first antenna conductor and that of the second is substantially (¼+n/2) times (n is an integer equal to or greater than 0) the wavelength of a signal in the first frequency band, on the antenna conductor. Additionally, the sum of the length of the second antenna conductor and that of the third is substantially (½+m/2) times (m is an integer equal to or greater than 0) the wavelength of a signal in the second frequency band, on the antenna conductor.

In the conductor composed of the second and third antenna conductors in the above-described first antenna device, (m+1)λ/2 resonance in the second frequency band occurs. For this reason, the resonance current hardly flows through the ground organizer, and most of the current is distributed only to the second and third antenna conductors. At this moment, downsizing these antenna conductors in such as a meander shape decreases the radiation resistance at the antenna conductor, and thus the influence by the loss resistance increases. Consequently, in the first antenna device, the received power in the second frequency band (i.e. a disturbing wave band) can be attenuated, thereby improving the reception quality of the first antenna device.

### BRIEF DESCRIPTION OF DRAWINGS

FIG. 1 is a schematic diagram of an electronic apparatus according to the first exemplary embodiment of the present invention.

FIG. 2 is a perspective view of the electronic apparatus according to the first embodiment.

FIG. 3 is another schematic diagram of the electronic apparatus according to the first embodiment.

FIG. 4 is a Smith chart in the first embodiment.

FIG. 5 is another schematic diagram of the electronic apparatus according to the first embodiment.

FIG. 6 is a Smith chart in the first embodiment.

FIG. 7 is another schematic diagram of the electronic apparatus according to the first embodiment.

FIG. 8 is a Smith chart in the first embodiment.

FIG. 9 is a circuit diagram of the electronic apparatus according to the first embodiment.

FIG. 10 is a perspective view of another electronic apparatus according to the first embodiment.

FIG. 11 is a perspective view of another electronic apparatus according to the first embodiment.

FIG. 12 is a perspective view of an antenna conductor according to the first embodiment.

FIG. 13 is another perspective view of the antenna conductor according to the first embodiment.

FIG. 14 is another perspective view of the electronic apparatus according to the first embodiment.

FIG. 15 is another perspective view of the electronic apparatus according to the first embodiment.

FIG. 16 is another perspective view of the antenna conductor according to the first embodiment.

FIG. 17 is a schematic diagram of a conventional electronic apparatus.

### REFERENCE MARKS IN THE DRAWINGS

7 Electronic apparatus

8 First antenna device

9 Second antenna device

10 Ground organizer

11 Feeding unit

12 First antenna conductor

13 Second antenna conductor

14 Third antenna conductor

15 Fourth antenna conductor

16 Field-effect transistor

17 Notch filter

18 Module

19 Fixing member

### DETAILED DESCRIPTION OF PREFERRED EMBODIMENTS

### First Exemplary Embodiment

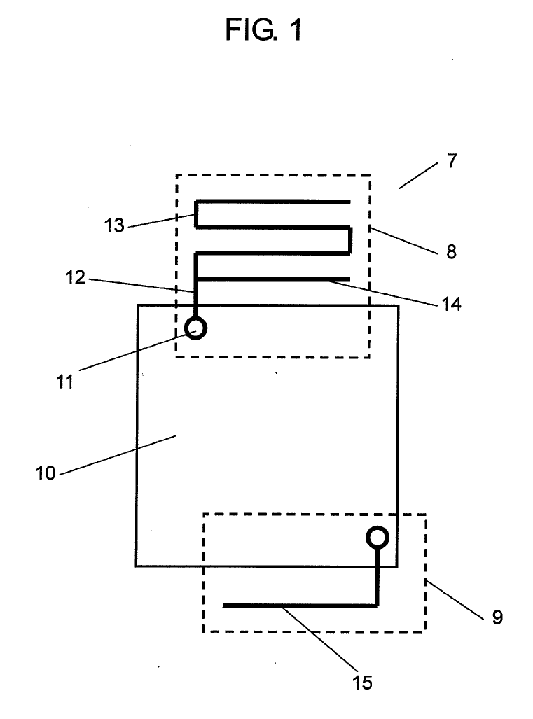

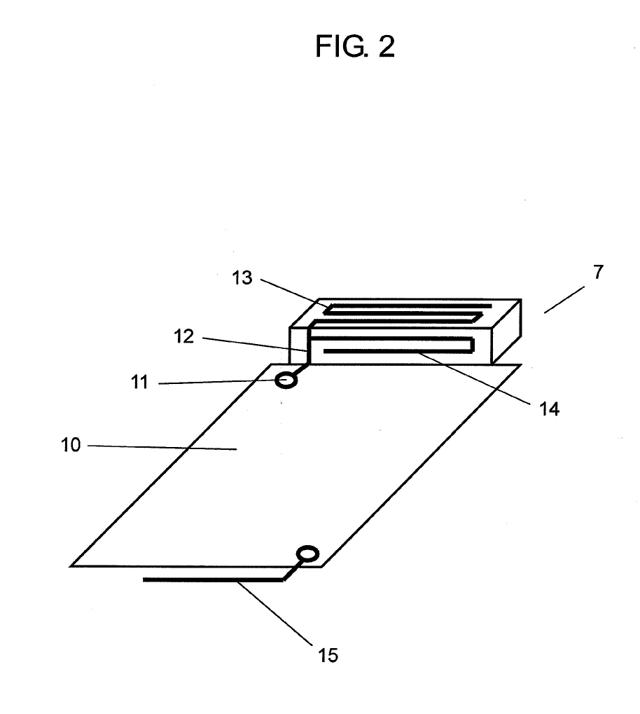

Hereinafter, a description is made of the first exemplary embodiment of the present invention using some related drawings. FIG. 1 is a schematic diagram of an electronic apparatus according to the first embodiment. FIG. 2 is a perspective view of the electronic apparatus according to the first embodiment. In FIG. 1, electronic apparatus 7 includes first antenna device 8, which is a first communication unit communicating using a first frequency band; and second antenna device 9, which is a second communication unit communicating using a second frequency band different from the first one.

First antenna device 8 includes ground organizer 10; feeding unit 11 placed on ground organizer 10; first antenna conductor 12 with its one end connected to feeding unit 11; and second antenna conductor 13 and third antenna conductor 14 both branch connected to the other end of first antenna conductor 12. The sum of the length of first antenna conductor 12 and that of second antenna conductor 13 is substantially ¼ times the wavelength of a signal in the first frequency band, on the antenna conductor, namely the wavelength after shortened by the influence of members around the antenna conductor, the ground organizer, and others. In addition, the sum of the length of second antenna conductor 13 and that of third antenna conductor 14 is substantially ½ times the wavelength of a signal in the second frequency band, on the antenna conductor. Second antenna device 9 further includes fourth antenna conductor 15 with a length substantially ¼ times the wavelength of a signal in the second frequency band, on the antenna conductor. Furthermore, as shown in FIG. 2, at least a part of second antenna conductor 13 or third antenna conductor 14 is meander-shaped, helical, spiral, or zigzag. That is, the distance from the end of the feed point of first antenna conductor 12 to the front end of third antenna conductor 14 is shorter than ½ times the wavelength of a signal in the second frequency band, on the antenna conductor.

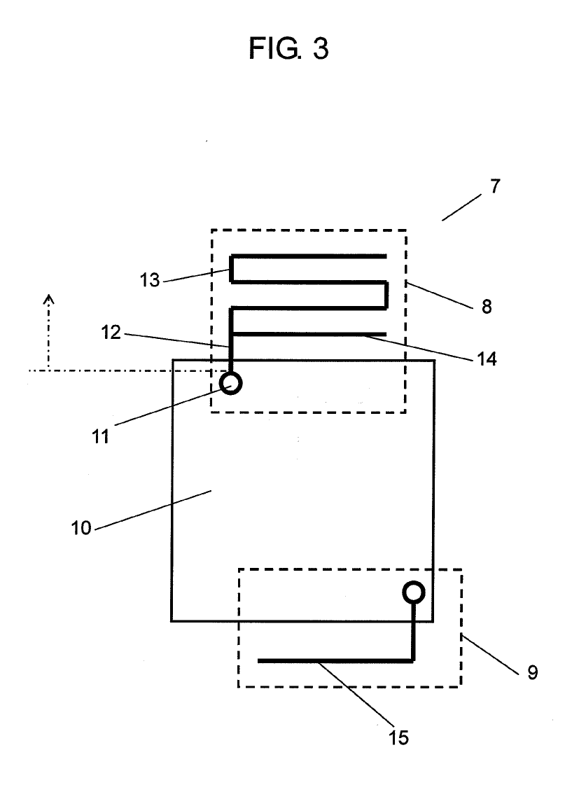

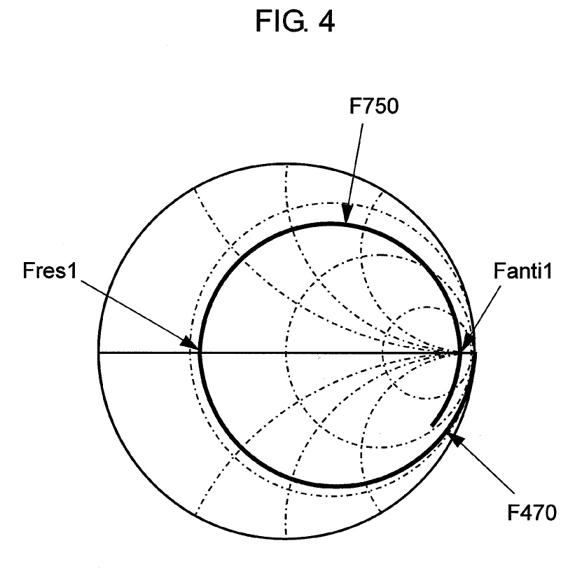

Here, an examination is made of the above-described configuration for a case where the first frequency band ranges from 470 MHz to 750 MHz; the second frequency band, from 824 MHz to 839 MHz, for example. FIG. 4 shows the locus of impedance allowing for the effect of the antenna conductor including first antenna conductor 12 shown by the arrow in FIG. 3, in a frequency range from 100 MHz to 1 GHz on a Smith chart. In FIG. 4, F470, F750, Fres1, and Fanti1 represent frequencies of 470 MHz, 750 MHz, 700 MHz, and 839 MHz, respectively. Halfway in the first frequency band, the λ/4 resonance point exists that is a point (Fres1) at which the impedance changes from capacitative to inductive. In the second frequency band, the λ/2 resonance point exists that is a point (Fanti1) at which the impedance changes from inductive to capacitative. At this moment, λ/2 resonance occurs near the second frequency band, and impedance allowing for the effect of the antenna conductor is extremely high. Consequently, a resonance current hardly flows through the ground organizer, and most of the current is distributed only to the antenna conductor.

First antenna conductor 12, second antenna conductor 13, and third antenna conductor 14, all composing this antenna conductor are meander-shaped or in another shape, the radiation resistance at antenna conductors 12, 13, 14 decreases, and thus the influence by the loss resistance increases. Consequently, in first antenna device 8, the received power in the second frequency band (i.e. a disturbing wave band) can be attenuated, thereby improving the reception quality in first antenna device 8. The received power is attenuating due to such a decrease in radiation resistance continuously at frequencies near Fanti1. That is to say, a certain degree of attenuation amount can be yielded in the second frequency band even if Fanti1 is out of the second frequency band.

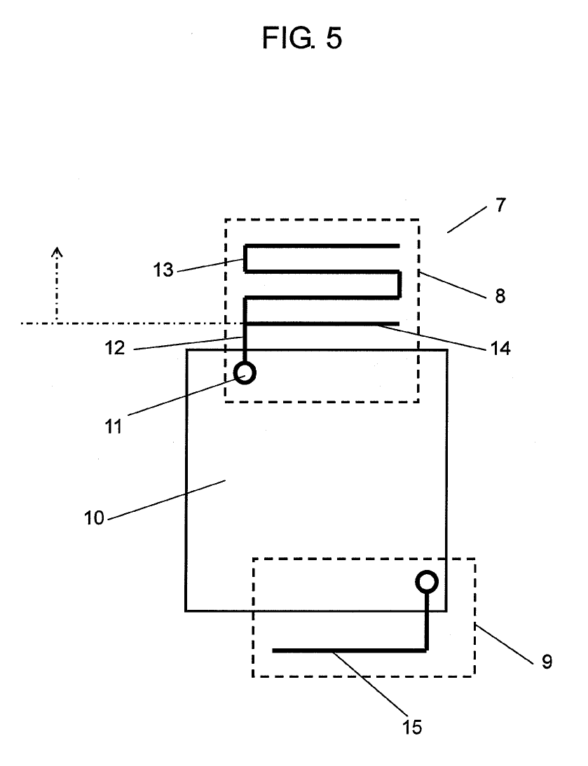

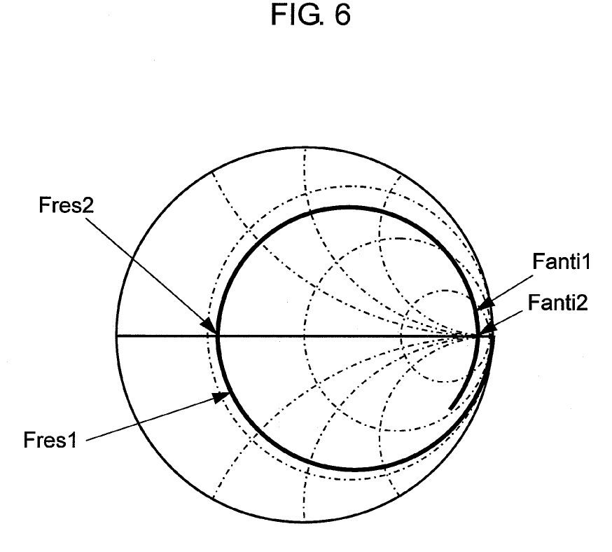

FIG. 6 shows the locus of impedance allowing for the effect of the antenna conductor excluding first antenna conductor 12, shown by the arrows in FIG. 5, in a frequency range from 100 MHz to 1 GHz on a Smith chart. In FIG. 6, Fres2 and Fanti2 represent frequencies of 720 MHz and 885 MHz, respectively. For the impedance allowing for the effect of the antenna conductor form the position shown by the arrows in FIG. 5, Fres1 and Fanti1 shift from the positions shown in FIG. 4 by the length of first antenna conductor 12 as shown in FIG. 6. λ/4 resonance occurs at Fres2 and λ/2 resonance occurs at Fanti2.

That is to say, when the frequency desired to be attenuated most in the disturbing wave band is Fanti1, determining the lengths of second antenna conductor 13 and third antenna conductor 14 in accordance with a frequency (Fanti2) higher than Fanti1 by the difference allowing for the length of first antenna conductor 12 allows the attenuation frequency to be adjusted to Fanti1. First antenna conductor 12 may include such as a planar spring and pogo pin used for feeding, implemented on the substrate of the ground organizer.

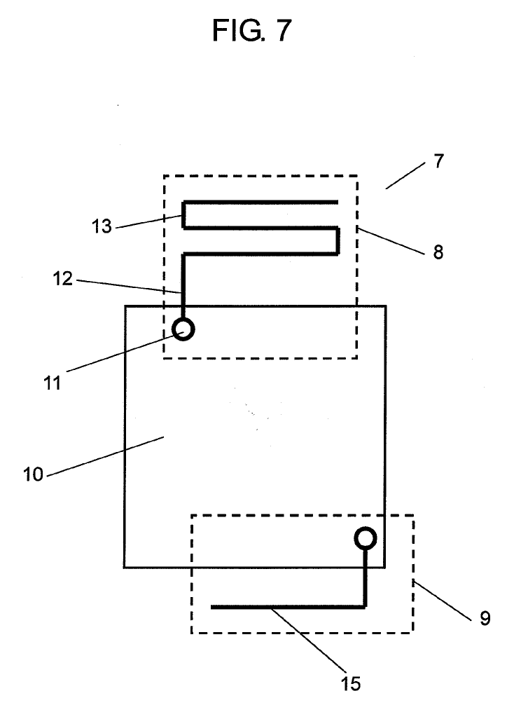

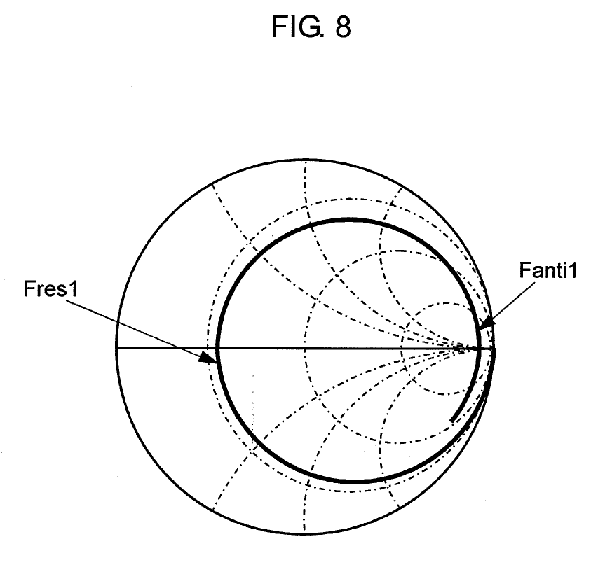

Here, an examination is made of a case where third antenna conductor 14 is not provided in FIG. 1. FIG. 7 is FIG. 1 without third antenna conductor 14. FIG. 8 shows the locus of impedance at the moment allowing for the effect of the part from the feed point to the antenna, in a frequency range from 100 MHz to 1 GHz on a Smith chart. Here, as shown in FIG. 8, Fres1 shifts from the λ/4 resonance point by approximately 4 MHz, and Fanti1 shifts from the λ/2 resonance point by approximately 12 MHz, as compared to the positions in FIG. 4, respectively. This proves that the frequencies in the second frequency band (i.e. disturbing wave band) shift to a larger degree than those in the first frequency band (i.e. desired wave band), and the length of third antenna conductor 14 largely influences the λ/2 resonance frequency.

Hence, changing the length of third antenna conductor 14 allows the attenuation band in which λ/2 resonance occurs to be adjusted independently of the desired wave band. Here in first antenna device 8, when the wavelength of a signal in the first frequency band, on the antenna conductor is substantially 2k (k is an integer equal to or greater than 1) times that in the second frequency band, the length of third antenna conductor 14 may be 0. In this case, first antenna device 8 produces (2n+1)λ/4 (n is an integer equal to or greater than 0)) resonance in the first frequency band using first antenna conductor 12 and second antenna conductor 13, and produces (m+1)λ/2 (m is an integer equal to or greater than 0)) resonance in the second frequency band using second antenna conductor 13, thereby providing the same effects as the above.

First antenna device 8 may produce (2n+1)λ/4 (n is an integer equal to or greater than 0) resonance in the first frequency band using first antenna conductor 12 and second antenna conductor 13, and may produce (m+1)λ/2 (m is an integer equal to or greater than 0) resonance in the second frequency band using second antenna conductor 13 and third antenna conductor 14. That is, when the sum of the length of first antenna conductor 12 and that of second antenna conductor 13 is substantially (¼+n/2) times the wavelength of a signal in the first frequency band, on the antenna conductor, and additionally when the sum of the length of second antenna conductor 13 and that of third antenna conductor 14 is substantially (½+m/2) times the wavelength of a signal in the second frequency band, on the antenna conductor, the same effects as the above are provided.

However, to load a mobile phone, for example, with electronic apparatus 7, n is desirably zero for downsizing. In such a case, an assumed disturbing wave is in the cellular communication band, assuming that a desired wave band in the second frequency band is the digital television band, and thus m is desirably set as m 2, where the cellular band is present. Here, the sum of the length of first antenna conductor 12 and that of second antenna conductor 13 does not need to be exactly (¼+n/2) times the wavelength of a signal in the first frequency band, on the antenna conductor; the sum of the length of second antenna conductor 13 and that of third antenna conductor 14 does not need to be exactly (½+m/2) times the wavelength of a signal in the second frequency band, on the antenna conductor. That is, when the sums are within a range approximately ±15% of (¼+n/2) times the wavelength of a signal in the first frequency band and of (½+m/2) times the wavelength of a signal in the second frequency band, respectively, the received power in the second frequency band can be attenuated, thereby providing the same effects as the above.

First antenna device 8 may use first antenna conductor 12 and third antenna conductor 14 to attenuate the received power in the second frequency band (i.e. disturbing wave band). That is, even if the sum of the length of first antenna conductor 12 and that of third antenna conductor 14 is substantially (½+m/2) times (m is an integer equal to or greater than 0) the wavelength of a signal in the second frequency band, on the antenna conductor, the same effects as the above are available. In this case, at least a part of first antenna conductor 12 or third antenna conductor 14 is meander-shaped, helical, spiral, or zigzag. That is, the distance from feeding unit 11 to the front end of third antenna conductor 14 is shorter than (m+1)/2 times the wavelength of a signal in the second frequency band, on the antenna conductor.

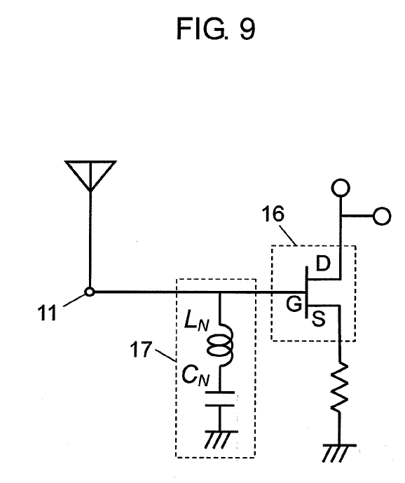

As shown in FIG. 9, electronic apparatus 7 desirably includes source-grounded or drain-grounded field-effect transistor 16 with gate G connected to feeding unit 11; and notch filter 17 for attenuating a signal in the second frequency band, grounded in shunt between feeding unit 11 and field-effect transistor 16. Herewith, the input impedance of antenna conductors 12, 13, 14 viewed from feeding unit 11 in the second frequency band (i.e. disturbing wave band) is high, and additionally the input impedance of source-grounded or drain-grounded field-effect transistor 16 is high as well. Furthermore, the low impedance of notch filter 17 connected between feeding unit 11 and field-effect transistor 16 produces a large difference in the impedance between antenna conductors 12, 13, 14 and notch filter 17; and notch filter 17 and field-effect transistor 16. Consequently, a great filter effect is available in addition to the effect of removing an interference band. Instead of field-effect transistor 16, a collector-grounded transistor (not shown) provides the same effect.

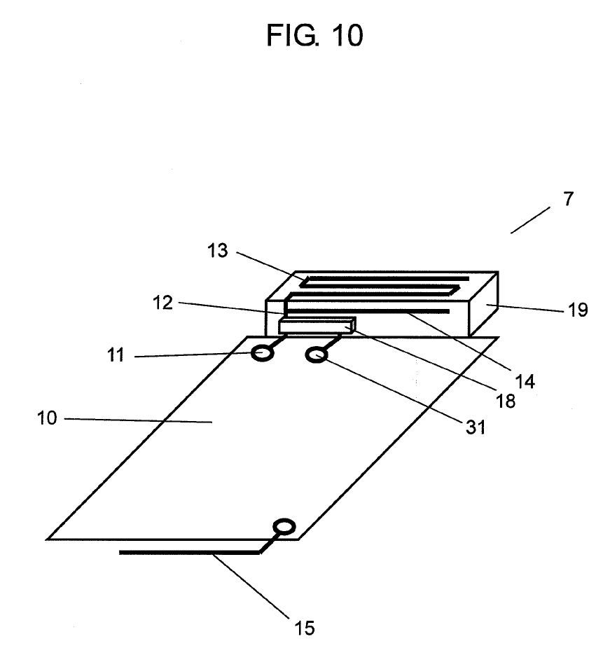

Furthermore, as shown in FIG. 10, field-effect transistor 16 and notch filter 17 are desirably arranged between antenna conductors 12, 13, 14 and ground organizer 10. For example, module 18 composed of field-effect transistor 16 and notch filter 17 is implemented on the side of fixing member 19 on which antenna conductors 12, 13, 14 are formed, to downsize electronic apparatus 7. The antenna performance of electronic apparatus 7 is determined mainly by positional relationship of ground organizer 10 and antenna conductors 12, 13, 14. Under the circumstances, module 18 is implemented on a surface closer to ground organizer 10 than antenna conductors 12, 13, 14 to downsize electronic apparatus 7 while reducing influence on the antenna performance. Here, ground organizer 10 is provided thereon with power terminal 31 for driving module 18.

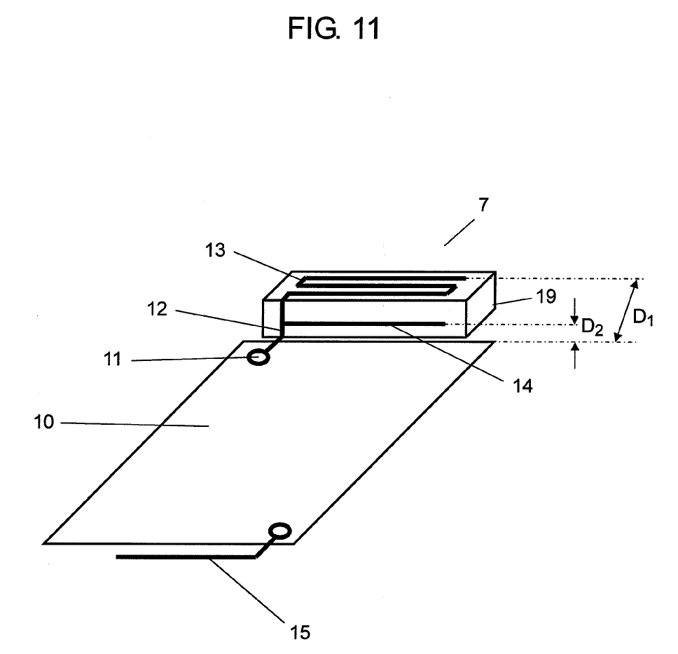

As shown in FIG. 11, the condition of D1/λ1≧D2/λ2 is desirably satisfied, where D1 is the distance from ground organizer 10 to the farthest point of second antenna conductor 13; D2, the distance from ground organizer 10 to the farthest point of third antenna conductor 14; λ1, the length of substantially 4 times the sum of the length of first antenna conductor 12 and that of second antenna conductor 13; λ2, the length of substantially 4 times the sum of the length of first antenna conductor 12 and that of third antenna conductor 14. This structure is to approximate third antenna conductor 14 to the ground. Herewith, the radiation efficiency in a frequency band of a signal with its wavelength substantially 4 times the length of first antenna conductor 12 and third antenna conductor 14. This reduces an unnecessary wave adversely affecting a circuit connected to feeding unit 11.

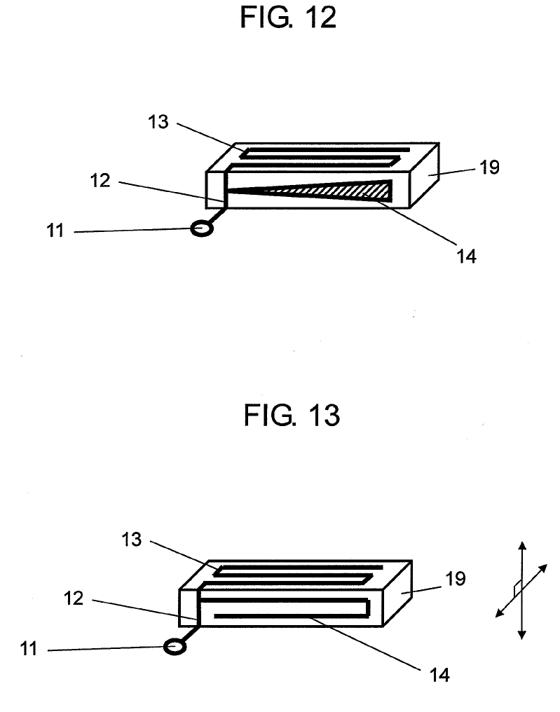

Further, as shown in FIG. 12, the width of third antenna conductor 14 may be uneven. For example, tapered third antenna conductor 14 causes itself to resonate at different wavelengths in the second frequency band. Herewith, a wide second frequency band (i.e. disturbance removal band) is available, thereby providing stable communications.

Furthermore, as shown in FIG. 13, the main polarization direction of second antenna conductor 13 and that of third antenna conductor 14 may be substantially orthogonal to each other. With this structure, a current through second antenna conductor 13 flows orthogonally to that through third antenna conductor 14, thereby weakening the mutual electromagnetic coupling. Consequently, when adjusting the frequencies of the first and second frequency bands, second antenna conductor 13 and third antenna conductor 14 can be designed with higher independence, providing easy adjustment.

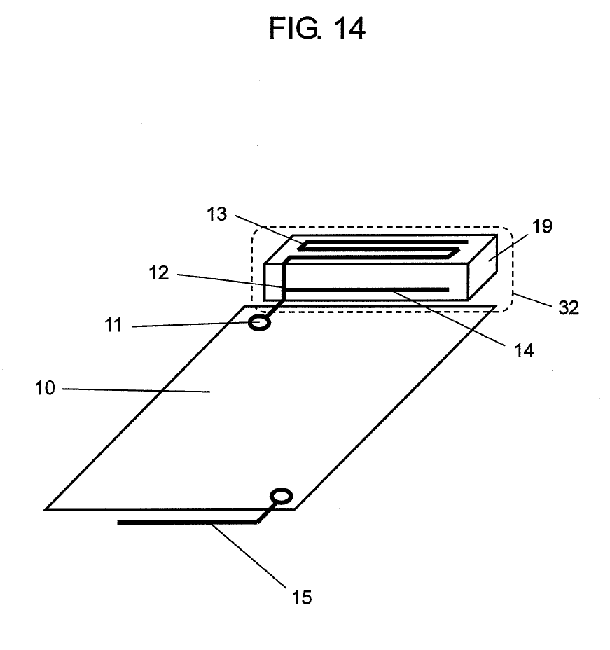

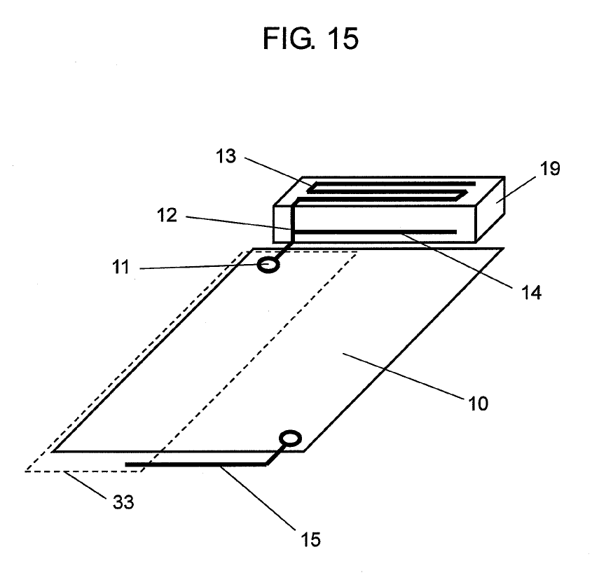

Further, fixing member 19 fixing first antenna conductor 12, second antenna conductor 13, and third antenna conductor 14 desirably contains at least one of a dielectric substance and magnetic substance. Dielectric and magnetic substances are loss materials. Consequently, as shown in FIG. 14, a current concentrates into region 32 in the disturbing wave band (second frequency band), radiation mainly occurs from the antenna conductor, and thus the loss component of a loss material exerts a prominent influence. This decreases the radiation efficiency in the disturbing wave band. Meanwhile, in the desired wave band (first frequency band), the current distribution exhibits an antinode at feeding unit 11. Consequently, as shown in FIG. 15, the current concentrates into region 33 in the desired wave band (first frequency band) and flows into ground organizer 10 to a large degree, resulting in predominant radiation from ground organizer 10. Hence, the loss material of fixing member 19 exerts a small influence, thereby restraining the radiation efficiency from deteriorating in the desired wave band to an extremely small degree.

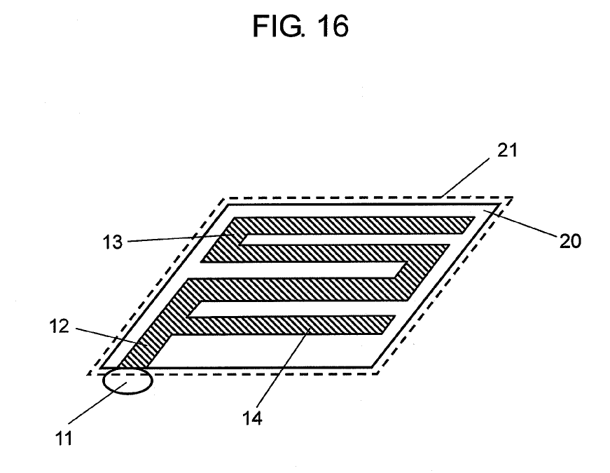

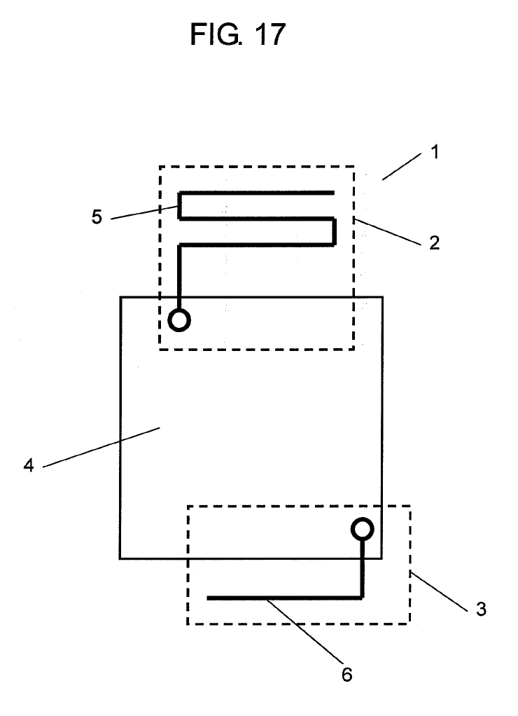

Further, as shown in FIG. 16, the antenna element including first antenna conductor 12, second antenna conductor 13, and third antenna conductor 14 may be film antenna 21 made of flexible wiring board 20 formed by printing a conductor on one surface of a dielectric film. The thickness of the conductor of film antenna 21 is usually 1 μm to 30 μm, thinner than an antenna conductor formed by sheet-metal process with a typical thickness of approximately 200 μm. That is, the cross-sectional area of film antenna 21 is smaller than that of a sheet-metal antenna, and thus film antenna 21 has a conductor resistance higher than a sheet-metal antenna, where the electric conductivity decreases to around a 1-digit number. Hence, as shown in FIG. 14, the radiation efficiency of an antenna can be depressed in the disturbing wave band (second frequency band) where the conductor resistance of the antenna conductor exerts a prominent influence.

Meanwhile, the current distribution exhibits an antinode at feeding unit 11 in the desired wave band (first frequency band), and thus as shown in FIG. 15, a current flows into ground organizer 10 to a large degree, resulting in predominant radiation from ground organizer 10. That is, in the desired wave band (first frequency band), the conductor resistance of the antenna conductor exerts a small influence, and thus even if film antenna 21 with a high conductor resistance is used, the radiation efficiency decreases to an extremely small degree in the desired wave band. In addition, using such film antenna 21 allows the antenna element to occupy only an extremely small region, and film antenna 21 further has flexibility to increase flexibility in arrangement, thereby downsizing the electronic apparatus as a whole.

Furthermore, field-effect transistor 16 and notch filter 17 shown in FIG. 9 may be implemented on flexible wiring board 20. Herewith, the distances from the antenna element to field-effect transistor 16 and notch filter 17 can be shortened, thereby reducing the change of impedance between the antenna element and notch filter 17. Consequently, the deviation of the rejection frequency in the disturbing wave band from the rejection frequency of notch filter 17, caused by λ/2 resonance on second antenna conductor 13 and third antenna conductor 14 is extremely small. This allows the received power in the second frequency band (i.e. disturbing wave band) to be attenuated efficiently, thereby improving the reception quality of first antenna device 8.

Here, even if flexible wiring board 20 is a flex rigid wiring board where only an area on which field-effect transistor 16 and notch filter 17 is a rigid board, the same effect is available.

### INDUSTRIAL APPLICABILITY

The present invention improves reception quality in an electronic apparatus equipped with plural antenna devices, useful for an electronic apparatus such as a mobile phone.

1-18. (canceled)

19. An electronic apparatus comprising:
a first communication unit receiving or transmitting using a first frequency band; and
a second communication unit receiving or transmitting using a second frequency band different from the first one,
wherein the first communication unit includes:
a ground organizer;
a feeding unit placed on the ground organizer; and
an antenna having a first antenna conductor with one end thereof connected to the feeding unit; and a second antenna conductor and a third antenna conductor both branch connected to an other end of the first antenna conductor,
wherein a sum of a length of the first antenna conductor and a length of the second antenna conductor is substantially (¼+n/2) times a wavelength of a signal in the first frequency band, on an antenna conductor, and additionally
wherein a sum of a length of the second antenna conductor and a length of the third antenna conductor is substantially (½+m/2) times a wavelength of a signal in the second frequency band, on an antenna conductor,
assuming n and m are integers equal to or greater than 0.

20. The electronic apparatus of claim 19, wherein a distance from a front end of the second antenna conductor to a front end of the third antenna conductor is shorter than a length of (m+1)/2 times a wavelength of a signal in the second frequency band, on an antenna conductor.

21. The electronic apparatus of claim 19, wherein at least a part of the second antenna conductor or the third antenna conductor is formed in a shape of meander, helical, or zigzag.

22. An electronic apparatus comprising:
a first antenna device communicating using a first frequency band; and
a second antenna device communicating using a second frequency band different from the first one,
wherein the first antenna device includes:
a ground organizer;
a feeding unit placed on the ground organizer;
a first antenna conductor with its one end connected to the feeding unit; and
a second antenna conductor and a third antenna conductor both branch connected to an other end of the first antenna conductor,
wherein sum of a length of the first antenna conductor and a length of the second antenna conductor is substantially (¼+n/2) times a wavelength of a signal in the first frequency band, on an antenna conductor, and additionally
wherein a sum of a length of the first antenna conductor and a length of the third antenna conductor is substantially (½+m/2) times a wavelength of a signal in the second frequency band, on an antenna conductor,
assuming n and m are integers equal to or greater than 0.

23. The electronic apparatus of claim 22, wherein a distance from the feeding unit to a front end of the third antenna conductor is shorter than a length of (m+1)/2 times a wavelength of a signal in the second frequency band, on an antenna conductor.

24. The electronic apparatus of claim 22, wherein at least a part of the first antenna conductor or the third antenna conductor is formed in a shape of meander, helical, spiral, or zigzag.

25. The electronic apparatus of Claim 22, further comprising:
a field-effect transistor with a gate connected to the feeding unit, or a collector-grounded transistor with a base connected to the feeding unit; and
a notch filter grounded in shunt between the feeding unit and the field-effect transistor, or between the feeding unit and the collector-grounded transistor, and attenuating a signal in the second frequency band.

26. The electronic apparatus of claim 25, wherein the field-effect transistor or the collector-grounded transistor, and the notch filter are arranged between the first, second, and third antenna conductors; and the ground organizer.

27. The electronic apparatus of claim 26, wherein the field-effect transistor or the collector-grounded transistor, and the notch filter are closer to the ground organizer than the first, second, and third antenna conductor.

28. The electronic apparatus of claim 19, wherein a condition of D1/λ1≧D2/λ2 is satisfied, where D1 is a distance from the ground organizer to a farthest point of the second antenna conductor; D2 is a distance from the ground organizer to a farthest point of the third antenna conductor; λ1 is a length of substantially 4 times a sum of a length of the first antenna conductor and a length of the second antenna conductor; and λ2 is a length of substantially 4 times a sum of a length of the first antenna conductor and a length of the third antenna conductor.

29. The electronic apparatus of claim 19, wherein a width of the third antenna conductor is uneven.

30. The electronic apparatus of claim 19, wherein a main polarization direction of the second antenna conductor and that of the third antenna conductor are substantially orthogonal to each other.

31. The electronic apparatus of claim 19, wherein a fixing member fixing the first, second, and third antenna conductors contains at least one of dielectric and magnetic substances.

32. The electronic apparatus of claim 19, wherein an antenna element containing the first, second, and third antenna conductors is made of a flexible wiring board formed by printing a conductor on one surface of a dielectric film.

33. The electronic apparatus of claim 19, further comprising:
a field-effect transistor with a gate connected to the feeding unit, or a collector-grounded transistor with a base connected to the feeding unit; and
a notch filter grounded in shunt between the feeding unit and the field-effect transistor, or between the feeding unit and the collector-grounded transistor, and attenuating a signal in the second frequency band.

34. The electronic apparatus of claim 25, wherein the field-effect transistor or the collector-grounded transistor, and the notch filter are implemented on the flexible wiring board.

35. An antenna device comprising:
a ground organizer;
a feeding unit placed on the ground organizer;
a first antenna conductor with one end thereof connected to the feeding unit; and
a second antenna conductor and a third antenna conductor both branch connected to an other end of the first antenna conductor,
wherein a sum of a length of the first antenna conductor and a length of the second antenna conductor is substantially (¼+n/2) times a wavelength of a signal in the first frequency band used to communicate, on an antenna conductor, and additionally
wherein a sum of a length of the second antenna conductor and a length of the third antenna conductor is substantially (½+m/2) times a wavelength of a signal in the second frequency band, which is a disturbing wave band, on an antenna conductor,
assuming n and m are integers equal to or greater than 0.

36. An antenna device comprising:
a ground organizer;
a feeding unit placed on the ground organizer;
a first antenna conductor with one end thereof connected to the feeding unit; and
a second antenna conductor and a third antenna conductor both branch connected to an other end of the first antenna conductor,
wherein a sum of a length of the first antenna conductor and a length of the second antenna conductor is substantially (¼+n/2) times a wavelength of a signal in the first frequency band used to communicate, on an antenna conductor, and additionally
wherein a sum of a length of the first antenna conductor and a length of the third antenna conductor is substantially (½+m/2) times a wavelength of a signal in the second frequency band, which is a disturbing wave band, on an antenna conductor,
assuming n and m are integers equal to or greater than 0.
